(19) United States
(12) Patent Application Publication
(10) Pub. No.: US 2016/0363449 A1
(43) Pub. Date: Dec. 15, 2016

(54) APPARATUS AND METHOD FOR LOGGING PROPULSION DATA ASSOCIATED WITH A MANUAL MOBILITY ASSISTANCE DEVICE

(71) Applicant: Ohio State Innovation Foundation, Columbus, OH (US)

(72) Inventors: Sandra A. Metzler, Columbus, OH (US); Jad Mubaslat, Miamisburg, OH (US); Sarah Kinsey Shaffer, Westerville, OH (US); Lee K. Nishio, Columbus, OH (US); Kyle Allen Eakins, Hilliard, OH (US); Carmen P. DiGiovine, Columbus, OH (US)

(21) Appl. No.: 15/178,014

(22) Filed: Jun. 9, 2016

Related U.S. Application Data
(60) Provisional application No. 62/173,056, filed on Jun. 9, 2015.

(51) Int. Cl. G01C 21/18; G01C 19/42; A61G 5/00; G01C 22/00

(52) U.S. Cl. CPC G01C 21/18; G01C 22/00; G01C 19/42; A61G 5/00

(57) ABSTRACT

An example portable apparatus for logging propulsion data associated with a manual mobility assistance device is described herein. The portable apparatus can include an accelerometer configured to detect acceleration of the manual mobility assistance device, an angular position sensor configured to detect rotation of a wheel of the manual mobility assistance device, and a controller operably coupled to the accelerometer and the angular position sensor. The controller can include a processor and a memory operably coupled to the processor, the memory having computer executable instructions stored thereon, that when executed by the processor, cause the processor to receive acceleration data detected by the accelerometer and angular position data detected by the angular position sensor, and store the acceleration data and the angular position data in the memory. The accelerometer, the angular position sensor, and the controller can be configured to removably couple to the manual mobility assistance device.

### CROSS-REFERENCE TO RELATED APPLICATIONS

This application claims the benefit of U.S. provisional patent application No. 62/173,056, filed on Jun. 9, 2015, and entitled “SmartHub: Personal Fitness and Activity Tracking Device Designed for Manual Wheelchair User,” the disclosure of which is expressly incorporated herein by reference in its entirety.

### STATEMENT REGARDING FEDERALLY FUNDED RESEARCH

This invention was made with government support under Grant no. GRT00024560 awarded by the National Institute for Child Health and Development. The government has certain rights in the invention.

### BACKGROUND

Around 3.6 million individuals who have mobility impairments use manual wheelchairs to allow them to complete tasks with a greater degree of independence and stay involved in their communities [1]. However, due to the repetitive nature of the wheelchair stroke-cycle, injuries to the shoulder, elbow, wrist, and hand are extremely common. Over 73% of manual wheelchair uses experience some type of shoulder pain [2]. While age and activity level do correlate to injury rate, it is the repetitive trauma that occurs to the bone and soft tissue during wheelchair propulsion that is the main cause of these injuries [3]. The main way that healthcare professionals are able to reduce injury and pain rates is by ensuring wheelchair fit and then helping an individual minimize the force and frequency of the stroke cycle [4].

Unfortunately, there are no personal fitness tracking devices (e.g., FITBIT from Fitbit, Inc. of San Francisco, Calif.) designed for persons who use manual wheelchairs. The one existing tool that can track these metrics is the SmartWheel by Out-Front of Mesa, Ariz. (http://www.out-front.com/smartwheel_overview.php), but SmartWheel is designed for use only in a clinical setting. So, there is no way for persons who use a manual wheelchair or their healthcare professionals to objectively monitor personal fitness metrics and wheelchair use. In addition, with a price-tag of $20,000, SmartWheel is only economically feasible for use in a clinical setting [5]. This makes it impossible for healthcare professionals and wheelchair users to understand real world habits of wheelchair use. Further, SmartWheel weighs 9lbs, almost 25% of the total weight of a standard wheelchair, and it replaces one of the wheelchair's wheels while data is being collected. Therefore, it makes the individual's wheelchair significantly more difficult to propel and often unbalances it. While there are various devices that can track similar metrics for bicycles, these are difficult to adapt for use on a wheelchair [6-7].

### SUMMARY

Described herein is a portable apparatus for logging propulsion data designed for individuals who use manual mobility assistance devices (e.g., manual wheelchairs). The portable apparatus is configured to collect personal fitness data such as average velocity, distance traveled, periods of activity, strokes per day, stroke frequency, and average pushing force. The portable apparatus allows a user to work with his healthcare professional to monitor daily habits, reduce the risk of pain and injury, and live a healthier lifestyle.

An example portable apparatus for logging propulsion data associated with a manual mobility assistance device is described herein. The portable apparatus can include an accelerometer configured to detect acceleration of the manual mobility assistance device, an angular position sensor configured to detect rotation of a wheel of the manual mobility assistance device, and a controller operably coupled to the accelerometer and the angular position sensor. The controller can include a processor and a memory operably coupled to the processor, the memory having computer executable instructions stored thereon, that when executed by the processor, cause the processor to receive acceleration data detected by the accelerometer and angular position data detected by the angular position sensor, and store the acceleration data and the angular position data in the memory. The accelerometer, the angular position sensor, and the controller can be configured to removably couple to the manual mobility assistance device.

Alternatively or additionally, the portable apparatus can further include an angular velocity sensor configured to detect rotation of the manual mobility assistance device. The controller can be configured to receive and store in the memory angular velocity data detected by the angular velocity sensor.

Additionally, a weight of the portable apparatus can be less than about 20% of a weight of the manual mobility assistance device. Optionally, the weight of the portable apparatus can be less than about 10% of the weight of the manual mobility assistance device.

Alternatively or additionally, a weight of the portable apparatus can be less than about 3.5 pounds. Optionally, the weight of the portable apparatus can be less than about 1 pound.

Alternatively or additionally, the portable apparatus can include a housing configured to house at least one of the accelerometer, the angular position sensor, and the controller. The housing can be configured to removably couple to the manual mobility assistance device. Optionally, the housing can be configured to house the accelerometer, the angular position sensor, and the controller. Alternatively, the housing can optionally be configured to house the accelerometer and the controller, and the angular position sensor can optionally be arranged outside of the housing and can be coupled to the controller through a communication link. Alternatively or additionally, the housing can be coupled to a frame of the manual mobility assistance device. For example, the housing can be coupled between the frame and the wheel of the manual mobility assistance device. Optionally, the housing can occupy an area less than about 4 square inches.

Alternatively or additionally, the angular position sensor can be a reed switch. For example, the angular position sensor can further include a magnet. The magnet can be coupled to the wheel of the manual mobility assistance device, and the magnet can cause the reed switch to operate (e.g., open or close) when the magnet passes in proximity to the reed switch.

Alternatively or additionally, the controller can be configured to transmit the acceleration data and the angular position data to a remote computing device over a communication link.

Alternatively or additionally, the controller can be configured to calculate at least one of a stroke frequency or an average pushing force using the acceleration data. For example, the stroke frequency can be calculated based on one or more peaks in the acceleration data. Additionally, the average pushing force can be calculated based on a weight of a user of the manual mobility assistance device and respective magnitudes of the one or more peaks in the acceleration data.

Alternatively or additionally, the controller can be configured to calculate at least one of a distance travelled, an average velocity, or a time active using the angular position data. For example, the distance travelled can be calculated based on a circumference of the wheel of the manual mobility assistance device and the angular position data. Additionally, the average velocity can be calculated based on the distance travelled over a period of time.

Alternatively or additionally, the controller can be configured to calculate at least one of a frequency of wheelies, a frequency of traversing graded surfaces, or a frequency of traversing side-sloped surfaces using the angular velocity data.

Alternatively or additionally, the portable apparatus can further include a battery.

An example manual mobility assistance device is also described herein. The manual mobility assistance device can include the portable apparatus described herein.

An example method for logging propulsion data associated with a manual mobility assistance device is also described herein. The method can include providing a portable apparatus configured to removably couple to the manual mobility assistance device, receiving acceleration data detected by an accelerometer and angular position data detected by an angular position sensor, and storing the acceleration data and the angular position data in a memory.

Alternatively or additionally, the method can include calculating at least one of a stroke frequency or an average pushing force using the acceleration data. For example, the stroke frequency can be calculated based on one or more peaks in the acceleration data. Additionally, the average pushing force can be calculated based on a weight of a user of the manual mobility assistance device and respective magnitudes of the one or more peaks in the acceleration data.

Alternatively or additionally, the method can include calculating at least one of a distance travelled, an average velocity, or a time active using the angular position data. For example, the distance travelled can be calculated based on a circumference of the wheel of the manual mobility assistance device and the angular position data. Additionally, the average velocity can be calculated based on the distance travelled over a period of time.

Alternatively or additionally, the method can include receiving and storing in the memory angular velocity data detected by an angular velocity sensor. Additionally, the method can further include calculating at least one of a frequency of wheelies, a frequency of traversing graded surfaces, or a frequency of traversing side-sloped surfaces using the angular velocity data.

Other systems, methods, features and/or advantages will be or may become apparent to one with skill in the art upon examination of the following drawings and detailed description. It is intended that all such additional systems, methods, features and/or advantages be included within this description and be protected by the accompanying claims.

### BRIEF DESCRIPTION OF THE DRAWINGS

The components in the drawings are not necessarily to scale relative to each other. Like reference numerals designate corresponding parts throughout the several views.

FIG. 1 is a block diagram of an example portable apparatus for logging propulsion data associated with a manual mobility assistance device.

FIG. 2 is an example computing device.

FIGS. 3A-3C illustrates various arrangements of a portable apparatus on a wheelchair.

FIG. 4 illustrates an example control board 400 for the portable apparatus described herein.

FIG. 5 is a graph illustrating example acceleration data collected by an accelerometer.

FIG. 6A is a graph illustrating example raw acceleration data.

FIG. 6B is a graph illustrating the difference between example raw and filtered acceleration data.

FIG. 7 is a graph illustrating example angular position data collected by a reed switch.

FIG. 8 is a graph illustrating example average velocity calculated using angular position data collected by a reed switch.

### DETAILED DESCRIPTION

Unless defined otherwise, all technical and scientific terms used herein have the same meaning as commonly understood by one of ordinary skill in the art. Methods and materials similar or equivalent to those described herein can be used in the practice or testing of the present disclosure. As used in the specification, and in the appended claims, the singular forms “a,” “an,” “the” include plural referents unless the context clearly dictates otherwise. The term “comprising” and variations thereof as used herein is used synonymously with the term “including” and variations thereof and are open, non-limiting terms. The terms “optional” or “optionally” used herein mean that the subsequently described feature, event or circumstance may or may not occur, and that the description includes instances where said feature, event or circumstance occurs and instances where it does not. Ranges may be expressed herein as from “about” one particular value, and/or to “about” another particular value. When such a range is expressed, an aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint. While implementations will be described for logging propulsion data associated with a manual wheelchair using a portable apparatus, it will become evident to those skilled in the art that the implementations are not limited thereto.

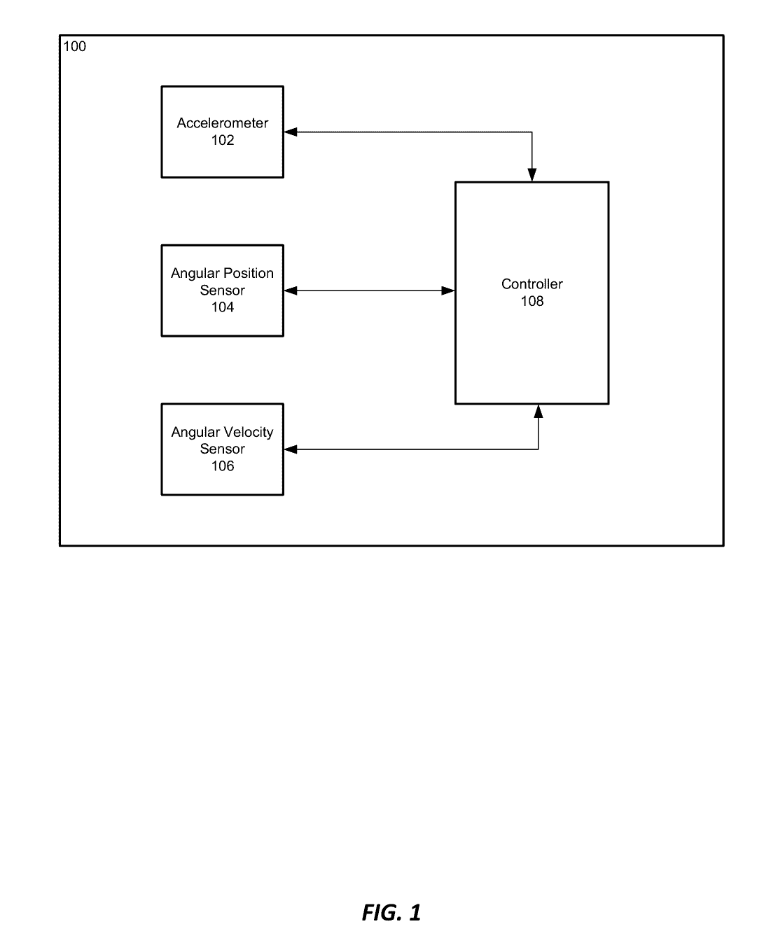

Referring now to FIG. 1, a block diagram of an example portable apparatus 100 for logging propulsion data associated with a manual mobility assistance device is shown. As used herein, a manual mobility assistance device can be a wheelchair, for example. A manual wheelchair is a chair with wheels that is self-propelled by the user, for example, by manually turning one or more of the propulsion wheels by hand. The portable apparatus 100 can include an accelerometer 102 configured to detect acceleration of the manual mobility assistance device. Accelerometers are used to measure acceleration forces and are known in the art. It should be understood that an accelerometer can be used in combination with a gyroscope and/or a magnetometer to determine position and orientation of an object. Additionally, the portable apparatus 100 can include an angular position sensor 104 configured to detect rotation of a wheel of the manual mobility assistance device. The angular position sensor 104 can be a reed switch, reflective sensor, interrupter sensor, encoder, magnetic sensor, capacitive sensor, or other proximity sensor that can detect rotation. For example, as described below, the angular position sensor 104 can optionally be a reed switch (e.g., a pair of electrical contacts configured to open/close based on magnetic field). Optionally, the portable apparatus 100 can include an angular velocity sensor 106 configured to detect rotation (e.g., pitch, roll, and/or yaw) of the manual mobility assistance device itself. The angular velocity sensor 106 can be a gyroscope, for example. As described above, it should be understood that a gyroscope can be used in combination with an accelerometer and/or a magnetometer to determine position and orientation of an object.

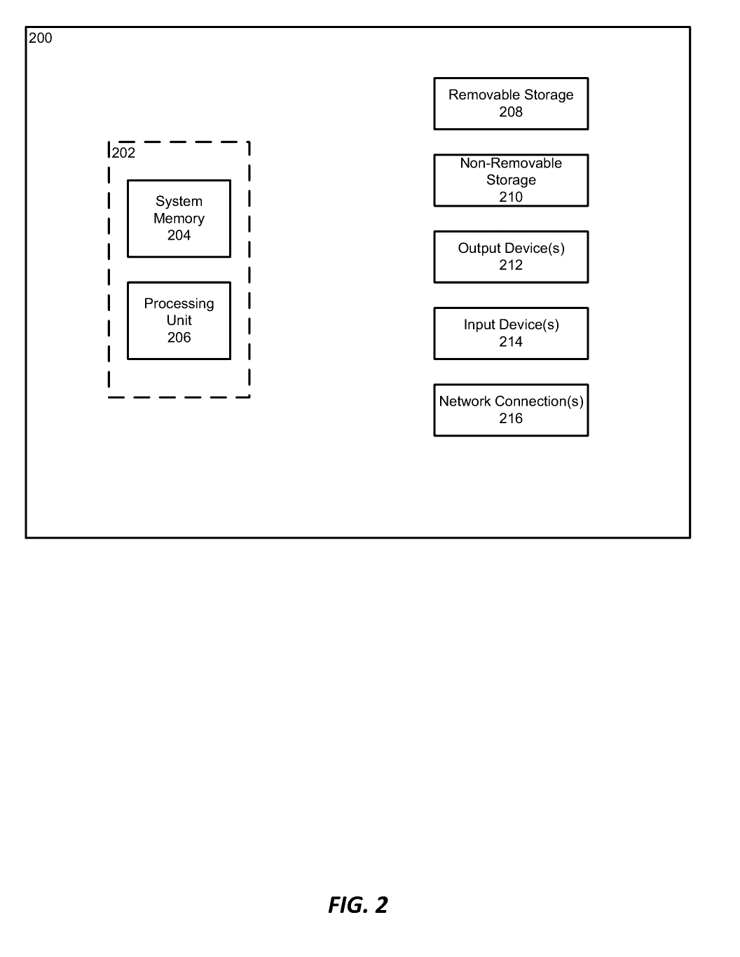

The portable apparatus 100 can also include a controller 108. The controller 108 can include a processor and a memory operably coupled to the processor. For example, the controller 108 can be a computing device (e.g., computing device 200 of FIG. 2). Optionally, the controller 108 can be a microcontroller such as the ARDUINO PRO-MINI, for example. The accelerometer 102, the angular position sensor 104, and the angular velocity sensor 106 can be operably coupled to the controller 108, for example, through one or more communication links. This disclosure contemplates the communication links are any suitable communication link. For example, a communication link may be implemented by any medium that facilitates data exchange between components including, but not limited to, wired, wireless and optical links. The processor 108 can be configured to receive acceleration data detected by the accelerometer 102 and angular position data detected by the angular position sensor 104, and store the acceleration data and the angular position data in the memory. Optionally, in implementations including an angular velocity sensor, the processor 108 can be further configured to receive angular velocity data detected by the angular velocity sensor 106, and store the angular velocity data in the memory. By storing the acceleration and angular position data and optionally angular velocity data, it should be understood that the portable apparatus 100 is configured to log propulsion data associated with the manual mobility assistance device.

The portable apparatus 100 (and its components such as the accelerometer 102, the angular position sensor 104, the angular velocity sensor 106, and/or the controller 108) can be configured to removably couple to the manual mobility assistance device. As used herein, removably couple means that the portable apparatus 100 (and its components) can be easily attached to/detached from a manual mobility assistance device, for example, without substantial modification of the manual mobility assistance device. This is in contrast to the SmartWheel described above, which replaces a wheel of the wheelchair and therefore limits usefulness to clinical applications only. For example, the portable apparatus 100 (and its components) can optionally be attached to the manual mobility assistance device using adhesive (e.g., tape, glue, VELCRO, etc.) and/or fasteners (e.g., screws, clips, etc.). This disclosure contemplates that attaching/detaching can be performed by the user and/or healthcare provider and can also be performed outside of a clinical setting (e.g., at the user's home). Additionally, this disclosure contemplates that the portable apparatus can be designed to fit manual mobility assistance devices of various shapes/sizes. The portable apparatus 100 does not impede the user of the manual mobility assistance device and/or unbalance or burden the manual mobility assistance device.

It should be appreciated that the logical operations described herein with respect to the various figures may be implemented (1) as a sequence of computer implemented acts or program modules (i.e., software) running on a computing device (e.g., the computing device described in FIG. 2), (2) as interconnected machine logic circuits or circuit modules (i.e., hardware) within the computing device and/or (3) a combination of software and hardware of the computing device. Thus, the logical operations discussed herein are not limited to any specific combination of hardware and software. The implementation is a matter of choice dependent on the performance and other requirements of the computing device. Accordingly, the logical operations described herein are referred to variously as operations, structural devices, acts, or modules. These operations, structural devices, acts and modules may be implemented in software, in firmware, in special purpose digital logic, and any combination thereof. It should also be appreciated that more or fewer operations may be performed than shown in the figures and described herein. These operations may also be performed in a different order than those described herein.

Referring to FIG. 2, an example computing device 200 upon which embodiments of the invention may be implemented is illustrated. It should be understood that the example computing device 200 is only one example of a suitable computing environment upon which embodiments of the invention may be implemented. Optionally, the computing device 200 can be a well-known computing system including, but not limited to, personal computers, servers, handheld or laptop devices, multiprocessor systems, microprocessor-based systems, network personal computers (PCs), minicomputers, mainframe computers, embedded systems, and/or distributed computing environments including a plurality of any of the above systems or devices. Distributed computing environments enable remote computing devices, which are connected to a communication network or other data transmission medium, to perform various tasks. In the distributed computing environment, the program modules, applications, and other data may be stored on local and/or remote computer storage media.

In its most basic configuration, computing device 200 typically includes at least one processing unit 206 and system memory 204. Depending on the exact configuration and type of computing device, system memory 204 may be volatile (such as random access memory (RAM)), non-volatile (such as read-only memory (ROM), flash memory, etc.), or some combination of the two. This most basic configuration is illustrated in FIG. 2 by dashed line 202. The processing unit 206 may be a standard programmable processor that performs arithmetic and logic operations necessary for operation of the computing device 200. The computing device 200 may also include a bus or other communication mechanism for communicating information among various components of the computing device 200.

Computing device 200 may have additional features/functionality. For example, computing device 200 may include additional storage such as removable storage 208 and non-removable storage 210 including, but not limited to, magnetic or optical disks or tapes. Computing device 200 may also contain network connection(s) 216 that allow the device to communicate with other devices. Computing device 200 may also have input device(s) 214 such as a keyboard, mouse, touch screen, etc. Output device(s) 212 such as a display, speakers, printer, etc. may also be included. The additional devices may be connected to the bus in order to facilitate communication of data among the components of the computing device 200. All these devices are well known in the art and need not be discussed at length here.

The processing unit 206 may be configured to execute program code encoded in tangible, computer-readable media. Tangible, computer-readable media refers to any media that is capable of providing data that causes the computing device 200 (i.e., a machine) to operate in a particular fashion. Various computer-readable media may be utilized to provide instructions to the processing unit 206 for execution. Example tangible, computer-readable media may include, but is not limited to, volatile media, non-volatile media, removable media and non-removable media implemented in any method or technology for storage of information such as computer readable instructions, data structures, program modules or other data. System memory 204, removable storage 208, and non-removable storage 210 are all examples of tangible, computer storage media. Example tangible, computer-readable recording media include, but are not limited to, an integrated circuit (e.g., field-programmable gate array or application-specific IC), a hard disk, an optical disk, a magneto-optical disk, a floppy disk, a magnetic tape, a holographic storage medium, a solid-state device, RAM, ROM, electrically erasable program read-only memory (EEPROM), flash memory or other memory technology, CD-ROM, digital versatile disks (DVD) or other optical storage, magnetic cassettes, magnetic tape, magnetic disk storage or other magnetic storage devices.

In an example implementation, the processing unit 206 may execute program code stored in the system memory 204. For example, the bus may carry data to the system memory 204, from which the processing unit 206 receives and executes instructions. The data received by the system memory 204 may optionally be stored on the removable storage 208 or the non-removable storage 210 before or after execution by the processing unit 206.

It should be understood that the various techniques described herein may be implemented in connection with hardware or software or, where appropriate, with a combination thereof. Thus, the methods and apparatuses of the presently disclosed subject matter, or certain aspects or portions thereof, may take the form of program code (i.e., instructions) embodied in tangible media, such as floppy diskettes, CD-ROMs, hard drives, or any other machine-readable storage medium wherein, when the program code is loaded into and executed by a machine, such as a computing device, the machine becomes an apparatus for practicing the presently disclosed subject matter. In the case of program code execution on programmable computers, the computing device generally includes a processor, a storage medium readable by the processor (including volatile and non-volatile memory and/or storage elements), at least one input device, and at least one output device. One or more programs may implement or utilize the processes described in connection with the presently disclosed subject matter, e.g., through the use of an application programming interface (API), reusable controls, or the like. Such programs may be implemented in a high level procedural or object-oriented programming language to communicate with a computer system. However, the program(s) can be implemented in assembly or machine language, if desired. In any case, the language may be a compiled or interpreted language and it may be combined with hardware implementations.

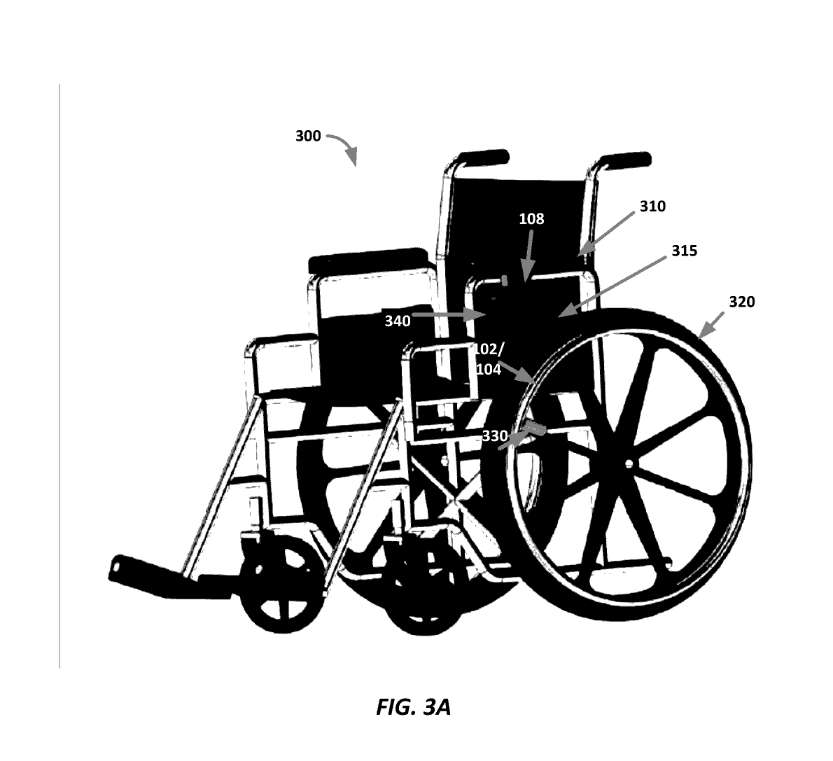

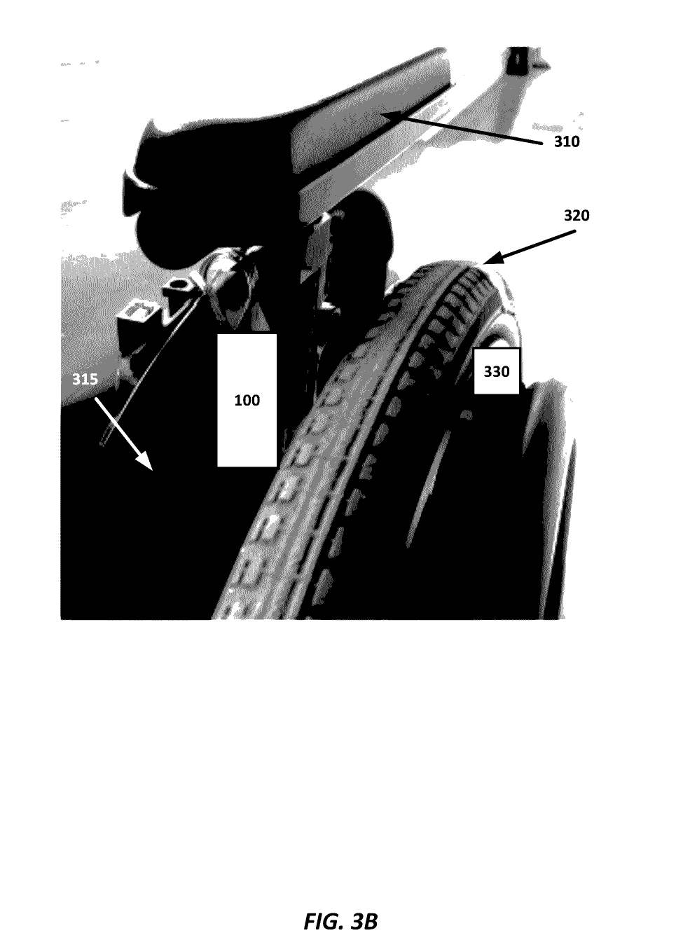

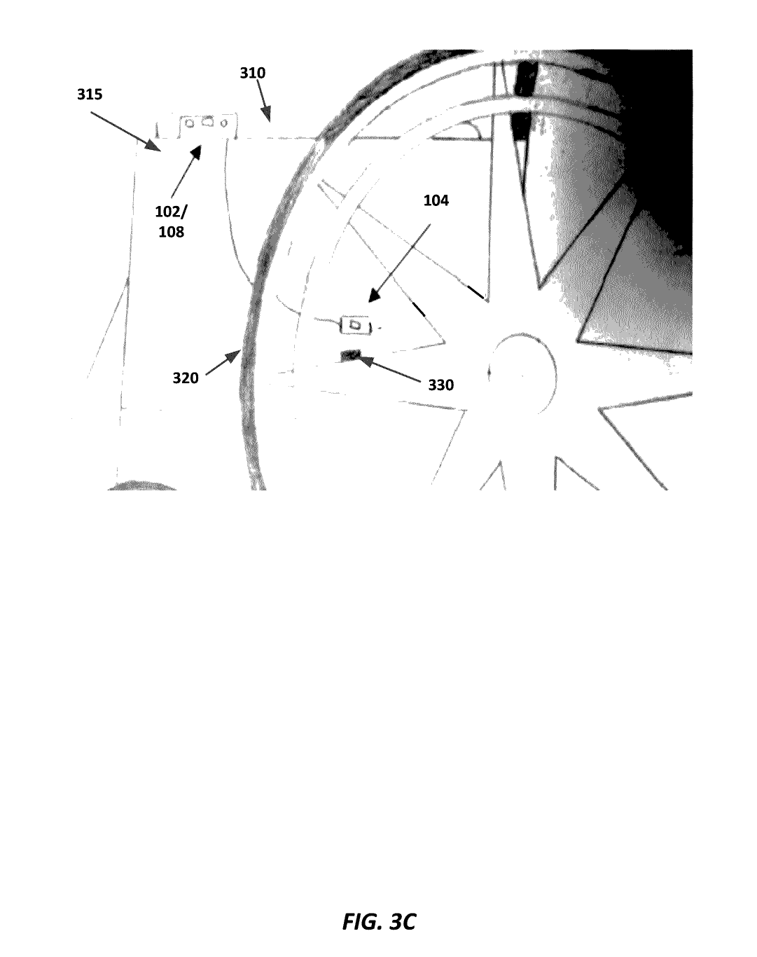

Referring now to FIGS. 3A-3C, various arrangements of a portable apparatus on a wheelchair 300 are shown. It should be understood that the various arrangements shown in FIGS. 3A-3C are provided only as examples and that other arrangements are possible in accordance with this disclosure. An arm 310, frame 315, and propulsion wheel 320 of the wheelchair 300 are shown in FIGS. 3A-3C for reference. As shown in FIG. 3A, the accelerometer 102, the angular position sensor 104, and the controller 108 removably couple to the wheelchair 300. In particular, the accelerometer 102, the angular position sensor 104, and the controller 108 are coupled between the frame 315 and the wheel 320 of the wheelchair 300. Additionally, as shown in FIG. 3A, the accelerometer 102/angular position sensor 104 and the controller 108 are enclosed by respective housings, which are coupled between the frame 315 and the wheel 320. In FIG. 3A, a USB port 340, which can be used for downloading sensor data from the portable apparatus, is also shown. Alternatively, as shown in FIG. 3B, the components of the portable apparatus 100 (e.g., an accelerometer, angular position sensor, and controller) are enclosed by a single housing, which is coupled between the frame 315 and the wheel 320. Alternatively, as shown in FIG. 3C, the accelerometer 102 and the controller 108 are enclosed in a housing coupled to the frame 315, and the angular position sensor 104 is arranged outside of the housing. As described above, the accelerometer 102, the angular position sensor 104, and the controller 108 can be operably coupled via one or more communication links. Further, it should be understood that an angular velocity sensor (e.g., angular velocity sensor 106 of FIG. 1) can optionally removably couple (and optionally within a housing with the other components of the portable apparatus) to the wheelchair 300.

In FIGS. 3A-3C, the angular position sensor 104 is a reed switch (e.g., a pair of electrical contacts configured to open/close based on magnetic field). Accordingly, the portable apparatus can further include a magnet 330 for operating the reed switch when the magnet 330 passes in proximity to the reed switch. In other words, the angular position sensor 104, which is coupled to the frame 315, is arranged such that the magnet 330 passes in proximity to the angular position sensor 104 as the wheel 320 rotates. The magnet 330 can be coupled to the wheel 320 of the wheelchair 300. For example, the magnet 330 is coupled to a spoke of the wheel 320 as shown in FIG. 3A or coupled to a portion of the wheel 320 (e.g., wheel's rim) as shown in FIG. 3B. Alternatively, as shown in FIG. 3C, the accelerometer 102 and the controller 108 are enclosed in a housing coupled to the frame 315, and the angular position sensor 104 is arranged outside of the housing and closer to the magnet 330, which is coupled to the wheel 320. The magnet 330 can optionally be attached to the wheel using adhesive and/or fasteners. As described below, data collected by the reed switch can be used to calculate distance traveled and average velocity, and as compared to a shaft encoder, a reed switch is less expensive and is more easily adapted to fit on wheelchairs of various shapes and sizes. Although a reed switch is provided as an example, this disclosure contemplates that other angular position sensors including, but not limited to, a reflective sensor, interrupter sensor, encoder, magnetic sensor, capacitive sensor, or other proximity sensor that can detect rotation of the propulsion wheel can be used.

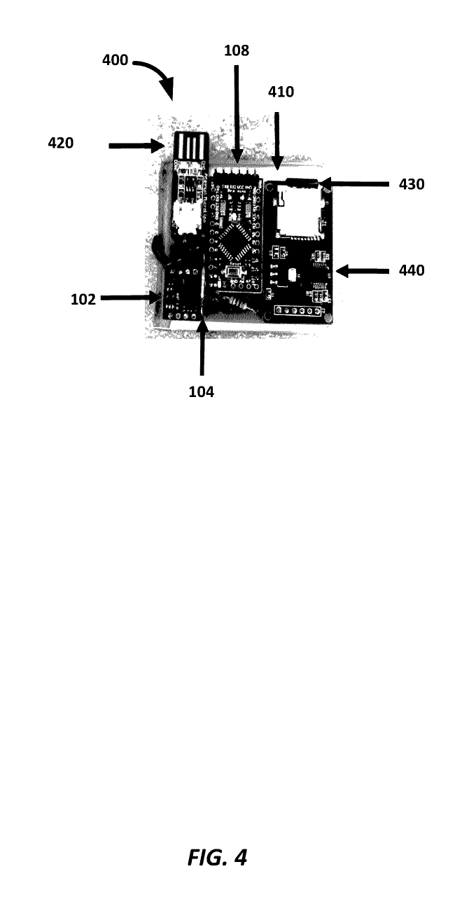

Referring now to FIG. 4, an example control board 400 for the portable apparatus described herein is shown. The accelerometer 102, the angular position sensor 104, and the controller 108 can be arranged on the control board 400. Optionally, an angular velocity sensor (e.g., angular velocity sensor 106 of FIG. 1) can also be arranged on the control board 400. Additionally, as shown in FIG. 4, a battery 410, battery charging port 420, removable storage (e.g., micro-SD card) 430, and removable storage reader port 440 can optionally be arranged on the control board 400. This disclosure contemplates that the control board 400 can be enclosed by a housing (not shown). Optionally, the housing can occupy an area less than about 4 square inches (e.g., about 2 inches×2 inches). It should be understood that the size and/or shape of the control board and/or housing can be different than as shown/described, which are provided only as examples.

Referring again to FIG. 1, the portable apparatus 100 can be configured to removably couple (e.g., easily attach to/detach from) to the manual mobility assistance device. In some implementations, the portable apparatus 100 can weigh less than about 20% of the weight of the manual mobility assistance device. Optionally, the portable apparatus 100 can weigh less than about 10% of the weight of the manual mobility assistance device. Alternatively or additionally, the portable apparatus 100 can weigh less than about 3.5 pounds. Optionally, the portable apparatus 100 can weigh less than about 1 pound. Optionally, the portable apparatus 100 can weigh less than about 0.5 pounds. Thus, the portable apparatus can be lightweight as compared to the SmartWheel, which weighs about 9 pounds or 25% of the weight of a standard wheelchair. Due to its light weight, the portable apparatus 100 does not impede the user of a wheelchair and/or unbalance or burden the wheelchair.

In some implementations, the controller 108 can be configured to transmit the acceleration data, the angular position data, and/or the angular velocity data to a remote computing device (not shown) over a communication link for further processing by the remote computing device. This disclosure contemplates that the remote computing device can by any computing device (e.g., computing device 200 of FIG. 2) such as a laptop, desktop, tablet, or mobile computing device. This disclosure contemplates the communication links are any suitable communication link. For example, a communication link may be implemented by any medium that facilitates data exchange between the controller 108 and the remote computing device including, but not limited to, wired, wireless and optical links. Example communication links include, but are not limited to, a LAN, a WAN, a MAN, Ethernet, the Internet, or any other wired or wireless link such as WiFi, WiMax, 3G or 4G. For example, in some implementations, the controller 108 and remote computing device can be operably connected by a USB cable, and the data can be transmitted over the USB cable. In other implementations, the controller 108 can include removable storage (e.g., the micro-SD card of FIG. 4), and the data can be transferred the remote computing device via removable storage.

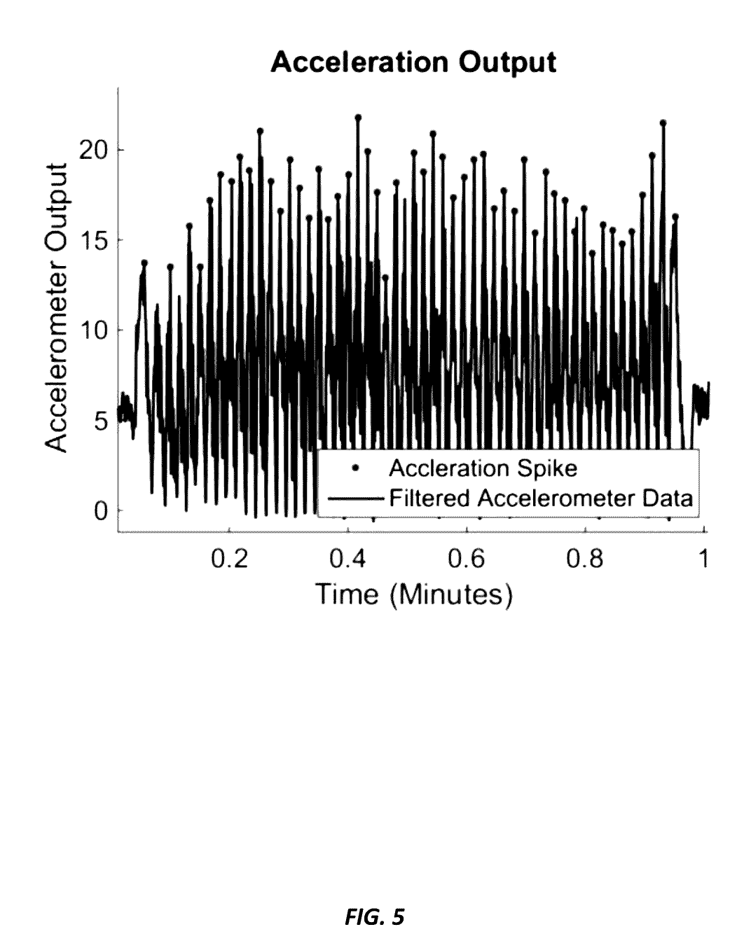

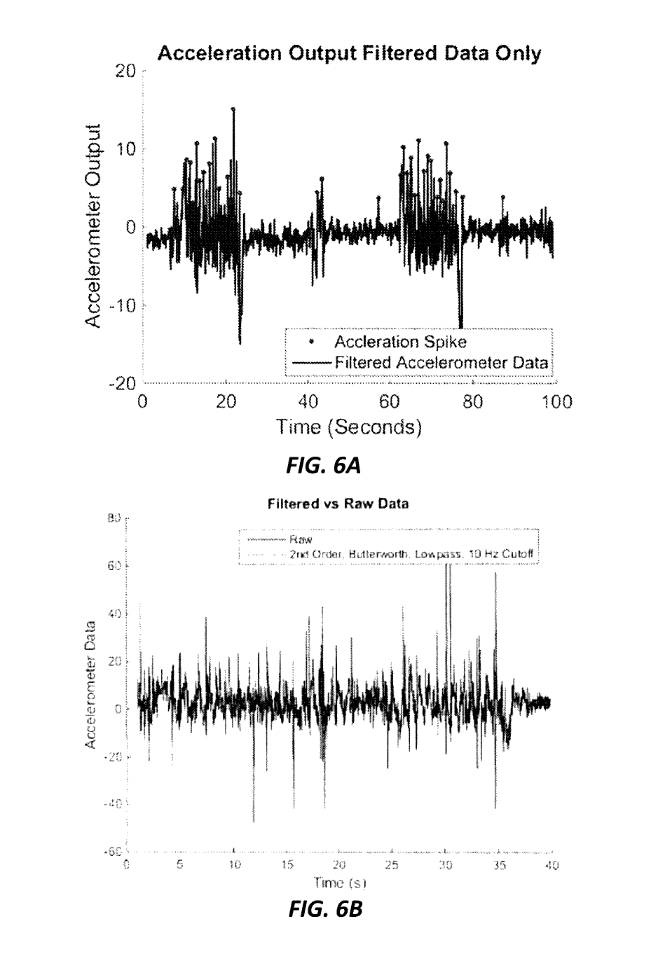

The controller 108 (or any computing device such as the remote computing device) can be configured to calculate at least one of a stroke frequency or an average pushing force using the acceleration data. Example acceleration data collected by an accelerometer is shown in FIG. 5. Optionally, the raw acceleration data (shown in FIG. 6A) can be filtered, for example, using a low-pass butterworth filter with a cutoff frequency 10 Hz. It should be understood that other filtering techniques including, but not limited to, Kalman filters can be used. The raw acceleration data from FIG. 6A was collected when the user went about 64 feet, stopped and rested for about 15 seconds, and returned to the starting position. FIG. 6A illustrates the resulting groupings of pushes. FIG. 6B illustrates the difference between raw and filtered acceleration data. The acceleration data from FIG. 6B was collected when the user went about 130 feet without stopping. Filtering can be used to remove noise from the data. It should be understood that information about a user's weight, wheelchair type, and/or propulsion wheel radius can be provided by the user, e.g., received and stored by the controller 108 or other computing device for use in the calculations. Stroke frequency and pushing force can be calculated using accelerometer data. When the user pushes on the handrim(s) to drive the propulsion wheel(s), there is a peak in the linear acceleration of the manual mobility assistance device as detected by the accelerometer. The peaks in the acceleration data can be used to calculate the stroke frequency (e.g., by counting the peaks during a period of time). Additionally, the magnitudes of the peaks in the acceleration data, along with the known weight of the user, can be used to calculate an average pushing force through inverse kinematic calculation, for example.

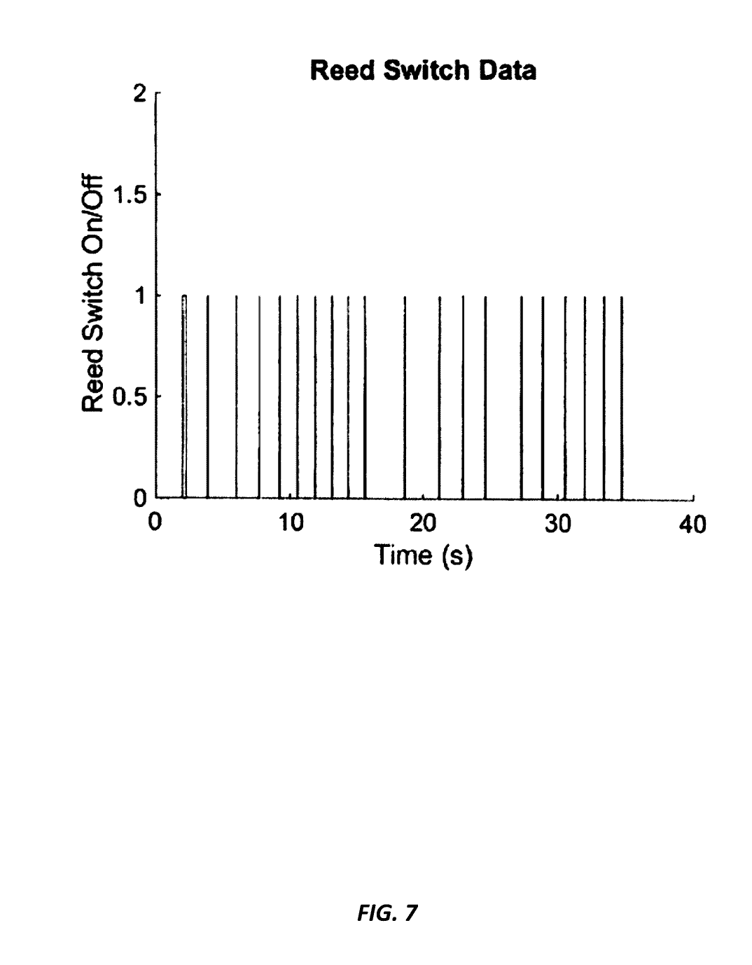

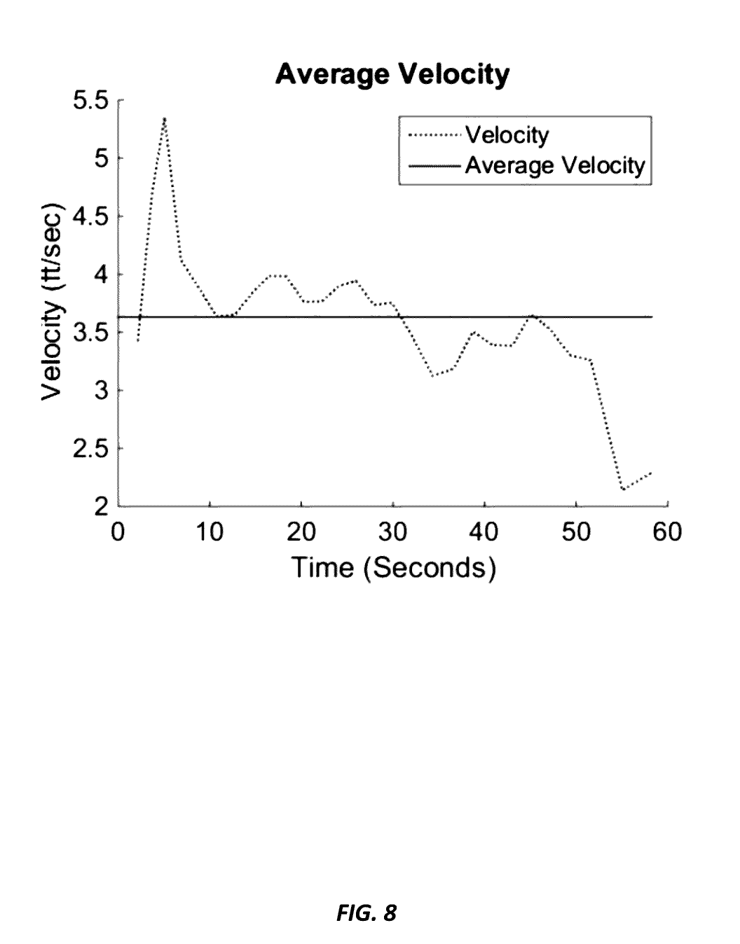

Alternatively or additionally, the controller 108 (or any computing device such as the remote computing device) can be configured to calculate at least one of a distance travelled, an average velocity, or a time active using the angular position data. As described above, the angular position sensor can be a reed switch. Example angular position data collected by a reed switch is shown in FIG. 7. It should be understood that information about a user's weight, wheelchair type, and/or propulsion wheel radius can be provided by the user, e.g., received and stored by the controller 108 or other computing device for use in the calculations. The distance travelled can be calculated using a circumference of the wheel of the manual mobility assistance device and the angular position data. For example, distance travelled can be calculated using the known circumference of the propulsion wheel and the number of times the magnet passes in proximity to the reed switch. Additionally, the average velocity can be calculated based on the distance travelled as calculated above over a period of time. It should be understood that the period of time can be any period of time such as a period of time selected by a user. For example, average velocity can be calculated based on the time between periods when the magnet passes in proximity to the reed switch. A graph illustrating average velocity is shown in FIG. 8. Additionally, time active can be calculated based on periods where the magnet passes in proximity to the reed switch more than a predetermined number of times in a fixed interval (e.g., once in a five second interval). If the magnet has not passed in proximity to the reed switch once in a five second interval, the propulsion wheel has not made a full revolution in that time, and the user has entered into a period of inactivity. It should be understood that the predetermined number of times and fixed interval can have values other than 1 and 5 seconds, which are provided only as examples.

Alternatively or additionally, the controller 108 (or any computing device such as the remote computing device) can be configured to calculate at least one of a frequency of wheelies, a frequency of traversing graded surfaces, or a frequency of traversing side-sloped surfaces using the angular velocity data. As described above, the angular velocity sensor can be a gyroscope, which can be used to measure pitch, roll, and/or yaw of the manual mobility assistance device. It should be understood that information about a user's weight, wheelchair type, and/or propulsion wheel radius can be provided by the user, e.g., received and stored by the controller 108 or other computing device for use in the calculations. Using the pitch, it is possible to calculate the frequency of transitory wheelies (e.g., a quick pop-up to get over a threshold or curb), a stationary wheelie (e.g., travel over soft surface such as grass). Alternatively or additionally, using the pitch in combination with the acceleration data, it is possible to calculate the frequency of traversing graded surfaces (e.g., traversing up/down hills). Alternatively or additionally, using the roll in combination with the acceleration data, it is possible to calculate the frequency of traversing side-slope on surfaces. Alternatively or additionally, using the yaw, it is possible to calculate the frequency of change in heading (e.g., maneuverability).

### Examples

### Device Design

One objective in designing the portable apparatus described herein was to create a personal fitness tracker for use on manual wheelchairs. The portable apparatus described herein is also designed to be safe to use, easy to use, lightweight, inexpensive, and durable. Ease-of-use was also a design constraint given that the population the portable apparatus described herein is intended for often has reduced manual dexterity and muscle weakness. Therefore, installation and data retrieval need to involve minimal user effort and be intuitive. In addition, the user-interface for viewing personal fitness metrics needs to be easy to navigate and understand.

The weight, cost, and durability of the portable apparatus described herein were also design considerations. In order to ensure that the portable apparatus described herein did not interfere with an individual's normal propulsion habits, it can be lightweight. As described above, in some implementations, the portable apparatus weighs less than 10% of standard wheelchair weight, or 3.5 lbs. In addition, users may not be able to get support from Medicare or Medicaid when purchasing the portable apparatus. Thus, another consideration was to design a portable apparatus that can be built for less than $150. Finally, another consideration was to design a portable apparatus that could be taken anywhere someone may need their wheelchair. So, the portable apparatus described herein can be water-resistant and firmly attachable to the frame of the wheelchair.

### Device Development

### Device Summary

In the example described below, the portable apparatus includes of two parts that removably couple to the wheelchair: a portable apparatus (e.g., portable apparatus 100 of FIG. 1) and a magnet (e.g., magnet 330 of FIGS. 3A-3C). The portable apparatus attaches between the frame of the wheelchair and the propulsion wheel, using either Velcro or double sided tape. The magnet is attached to one of the spokes on the wheel. The only restriction on portable apparatus placement is that the magnet must be able to pass over or in proximity to the controller when the wheel spins. The example portable apparatus includes removable memory (e.g., a micro-SD card as shown in FIG. 4) that can be removed and inserted into a card reader to download data onto a remote computer. The battery life is around 20 hours, so it can be used for an entire day before it needs to be recharged. The example portable apparatus weighs less than 1 lb and can be produced for $130. A housing can be provided (and even 3D printed) for the portable apparatus so that it can be protected from the elements when used outside.

### Electronics and Programming

The controller includes: an Arduino Pro-Mini, a reed switch, and an accelerometer (e.g., as shown in FIG. 4). The Arduino is the main processor for the portable apparatus. The reed switch is used to calculate distance traveled and time active, and the accelerometer is used to calculate stroke frequency and average pushing force. The controller also contains a port to hold a micro-SD card for data storage and a USB connection to charge the battery.

The calculations for distance traveled, time active, average velocity, stroke frequency, and pushing force were performed using MATLAB from MathWorks, Inc. of Natick, Mass. using the data (e.g., acceleration, angular position, and/or angular velocity data) downloaded from the portable apparatus. Distance traveled was calculated using the known circumference of the wheel, and by counting the number of times the magnet passes over the reed switch. Time active is determined by looking for periods where the magnet passes the reed switch more than once in a five second interval. If the magnet has not passed within five seconds, the wheel has not made a full revolution in those five seconds, and the user has entered into a period of inactivity. The average velocity was determined by knowing the time between periods when the magnet passes the reed switch.

Stroke frequency and pushing force were calculated using accelerometer data. When the user pushes on the handrim, there is a peak in the linear acceleration recorded by the wheelchair. These peaks can be used to determine push frequency. The magnitudes of these peaks can be used, along with the known weight of the user, to determine an approximate pushing force.

### Validation

In order to test device accuracy, three different trial types were performed. In all three trials, the portable apparatus's output from trials was compared to known quantities. For stroke count and time active, the number of strokes was manually counted while the periods activity or inactivity were manually timed. The first test was a preliminary testing of the MATLAB processing algorithm. For it, the individual in the wheelchair went 34 feet (about 10 meters), rested for 8 seconds, turned around, waited another 8 seconds, then went straight for 34 ft. The portable apparatus was able to calculate the number of strokes with only a 5% error: it counted 18 and there were only 17. It was also able to calculate distance traveled with a 23% error: it measured 52 feet but the wheelchair traveled 68 feet total. This error could be due to the fact that the reed switch did not always pass at the time the chair crossed the 34 foot mark. Because the reed switch is only reading one magnet on the wheel, the margin of error expected is the circumference of the wheel (in this case 6.2 feet). Additional magnets can optionally be attached to the wheel in order to improve the resolution for distance able to be read by the portable apparatus. There was less than 5% error for time active and time inactive. The device measured time active as 14.5 seconds and inactive as 26.7 seconds; this is very close to the time recorded manually.

In the second test, four trials were performed with the user travelling approximately 140 feet without resting. The course set-up for the 140 feet had four right hand turns, which is why the distance is approximate as the user did not make square turns in the corners. For these trials, the mean distance recorded by the portable apparatus was 125.65 feet; this is only a 10% error from the true distance. In addition, the mean push count was reported at 36 pushes, and the mean count measured by the portable apparatus using raw acceleration data was 33.6; this is only an 8.3% error. There was some difficulty filtering the acceleration data due to the large spikes seen at then sharp turns. This can be improved by using other filtering techniques. The stroke count was calculated with acceptable accuracy using the unfiltered data. In the third test, the user went 52 feet in straight line and three trials were recorded. The mean distance measured by the portable apparatus was 52.3 feet; this was extremely accurate with only a 0.5% error. The mean stroke count was 13.5, and the mean stroke count reported by the portable apparatus was 12.5; again, this was very accurate with only a 7% error.

### References

[1] M. W. Brault, Americans With Disabilities: 2010, Current Population Reports, United States Census Bureau, 2012.

[2] R. A. Cooper, M. L. Boninger and R. N. Robertson, “Repetitive Strain Injury Among Manual Wheelchair Users,” Team Rehab Report, vol. 9, no. 2, pp. 35-38, 1998.

[3] M. L. Boninger, J. D. Towers, R. A. Cooper, B. E. Dicianno and M. C. Munin, “Shoulder Imaging Abnormalities in Individuals with Paraplegia,” Journal of Rehabilitation Research & Development, vol. 38, no. 4, pp. 401-408, 2001.

[4] R. E. Cowan, M. L. Boninger, B. J. Sawatzky, B. Mazoyer and R. A. Cooper, “Preliminary Outcomes of the SmartWheel Users' Group Database: A Proposed Framework for Clinicians to Objectively Evaluate Manual Wheelchair Propulsion,” Archinves of Physical Medicine and Rehabilitation, vol. 89, pp. 260-268, 20008.

[5] “SmartWheel,” Out-Front, 2014. [Online]. Available: http://www.out-front.com/smartwheel_dataoutput.php. [Accessed 29 Oct. 2014].

[6] Copenhagen Wheel,” Superpedestrian, 2014. [Online]. Available: https://www.superpedestrian.com/. [Accessed 2014 Oct. 29].

[7] “Electron Wheel Review,” Electric Bike Review, 15 Dec. 2013. [Online]. Available: http://electricbikereview.com/currie/electron-wheel/. [Accessed 29 Oct. 2014].

[8] “Fitbit store,” Fitbit, 2014. [Online]. Avaliable: https://www.fitbit.com/store. [Accessed 29 Oct. 2014].

[9] “Nike Fuel+Band,” Amazon. 2014. [Online]. Avaliable: http://www.amazon.com/Nike-Fuel-Band/dp/B007FSEMPY. [Accessed 29 Oct. 2014].

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A portable apparatus for logging propulsion data associated with a manual mobility assistance device, comprising:
an accelerometer configured to detect acceleration of the manual mobility assistance device;
an angular position sensor configured to detect rotation of a wheel of the manual mobility assistance device; and
a controller operably coupled to the accelerometer and the angular position sensor, the controller comprising a processor and a memory operably coupled to the processor, the memory having computer executable instructions stored thereon, that when executed by the processor, cause the processor to:
receive acceleration data detected by the accelerometer and angular position data detected by the angular position sensor, and store the acceleration data and the angular position data in the memory;
wherein the accelerometer, the angular position sensor, and the controller are configured to removably couple to the manual mobility assistance device.

2. The portable apparatus of claim 1, wherein a weight of the portable apparatus is less than about 20% of a weight of the manual mobility assistance device.

3. (canceled)

4. The portable apparatus of claim 1, wherein a weight of the portable apparatus is less than about 3.5 pounds.

5. (canceled)

6. The portable apparatus of claim 1, further comprising a housing configured to house at least one of the accelerometer, the angular position sensor, and the controller, wherein the housing is configured to removably couple to the manual mobility assistance device.

7. (canceled).

8. (canceled)

9. The portable apparatus of claim 6, wherein the housing is coupled to a frame of the manual mobility assistance device.

10. The portable apparatus of claim 9, wherein the housing is coupled between the frame and the wheel of the manual mobility assistance device.

11. (canceled)

12. The portable apparatus of claim 1, wherein the angular position sensor comprises a reed switch.

13. The portable apparatus of claim 12, wherein the angular position sensor further comprises a magnet, and wherein the magnet is coupled to the wheel of the manual mobility assistance device.

14. The portable apparatus of claim 1, wherein the memory has further computer executable instructions stored thereon, that when executed by the processor, cause the processor to transmit the acceleration data and the angular position data to a remote computing device over a communication link.

15. The portable apparatus of claim 1, wherein the memory has further computer executable instructions stored thereon, that when executed by the processor, cause the processor to calculate at least one of a stroke frequency or an average pushing force using the acceleration data.

16. (canceled)

17. (canceled)

18. The portable apparatus of claim 15, wherein the memory has further computer executable instructions stored thereon, that when executed by the processor, cause the processor to calculate at least one of a distance travelled, an average velocity, or a time active using the angular position data.

19. (canceled)

20. (canceled)

21. The portable apparatus of claim 1, further comprising an angular velocity sensor configured to detect rotation of the manual mobility assistance device, wherein the memory has further computer executable instructions stored thereon, that when executed by the processor, cause the processor to receive and store in the memory angular velocity data detected by the angular velocity sensor.

22. (canceled)

23. The portable apparatus of claim 1, further comprising a battery.

24. (canceled)

25. A method for logging propulsion data associated with a manual mobility assistance device, comprising:
providing a portable apparatus configured to removably couple to the manual mobility assistance device, the portable apparatus comprising:
an accelerometer configured to detect acceleration of the manual mobility assistance device, and
an angular position sensor configured to detect rotation of a wheel of the manual mobility assistance device;
receiving acceleration data detected by the accelerometer and angular position data detected by the angular position sensor; and
storing the acceleration data and the angular position data in a memory.

26. The method of claim 25, further comprising calculating at least one of a stroke frequency or an average pushing force using the acceleration data.

27. (canceled)

28. (canceled)

29. The method of claim 25, further comprising calculating at least one of a distance travelled, an average velocity, or a time active using the angular position data.

30. (canceled)

31. (canceled)

32. The method of claim 25, wherein the portable apparatus further comprises an angular velocity sensor configured to detect rotation of the manual mobility assistance device, and wherein the method further comprises receiving and storing in the memory angular velocity data detected by the angular velocity sensor.

33. The method of claim 32, further comprising calculating at least one of a frequency of wheelies, a frequency of traversing graded surfaces, or a frequency of traversing side-sloped surfaces using the angular velocity data.

34. The method of claim 25, wherein the acceleration data and the angular position data are received over a communication link.

35. The method of claim 32, wherein the angular velocity data is received over a communication link.

36. (canceled)
